(19) United States
(12) Patent Application Publication
(10) Pub. No.: US 2007/0277678 A1
(43) Pub. Date: Dec. 6, 2007

(54) Multifunction electric cooker

(76) Inventor: Joy Mangano, St. James, NY (US)

Correspondence Address: Thomas M. Galgano, Esq. -;GALGANO & ASSOCIATES, PLLC, Suite 204, 20 W. Park Ave., Long Beach, NY, 11661, US

(21) Appl. No.: 11/436,075

(22) Filed: May 17, 2006

(51) Int. Cl. A47J 43/18; H05B 3/68

(52) U.S. Cl. 99/426; 219/453.12

(57) ABSTRACT

An electric cooker includes an upper burner and a lower burner which are adjustably coupled to a control platform. The lower burner is coupled to a pair of wheels (at least one of which is provided with a ratchet stop) which are rotatable about a horizontal axis such that the lower burner can be angled up from horizontal to 45° or more. The upper burner is coupled to the wheels by a pair of floating hinges so that the space between the upper and lower burners is automatically adjustable. The floating hinges are provided with notches and the control platform has a pair of movable bosses which engage the notches to keep the upper burner spaced a fixed distance above the lower burner. The floating hinges also allow for a full 180° rotation so that the upper and lower burners can be arranged as side by side burners. The control platform has separate digital temperature controls for the two burners and is also equipped with a digital timer which automatically turns the cooker off. A plurality of different cooking plates are removably coupled to the burners. These plates Include a smooth griddle plate, a ribbed grill plate, a waffle plate, as well as a saute pan. A removable drip tray is mounted in the control platform under the lower burner. The griddle plate, the grill the drip tray.

### BACKGROUND OF THE INVENTION

1. Field of the Invention

This invention relates broadly to electric cookers. More particularly, this Invention relates to an electric cooker having an upper burner and a lower burner, a plurality of different cooking plates attachable to the burners, separate temperature controls for the upper and lower burners, a floating hinge for the upper; burner and a rotating mount for the lower burner.

2. State of the Art

There are many different types of electric cookers available for home use. Recently, a popular cooker design has been a cooker having a pair of burners covered by grilling plates and hingedly coupled to each other in a manner similar to a waffle iron so that food may be cooked on two sides simultaneously. These cookers have some disadvantages. When cooking greasy food, there is no easy way to drain the grease. The space between the upper and lower burners is not readily adjustable. The grilling plates may have a surface which is not suitable for some cooking jobs. Temperature control is limited.

### SUMMARY OF THE INVENTION

It is therefore an object of the invention to provide a more versatile electric cooker.

It is another object of the Invention to provide an electric cooker that has upper and lower burners with separate temperature controls.

It is a further object of the Invention to provide an electric cooker which can drain grease as it is cooking.

It is also an object of the invention to provide an electric cooker which is adaptable to many different cooking needs

It is an additional object of the invention to provide an electric cooker having upper and lower burners with automatic and manual spacing of the burners relative to each other.

In accord with these objects, which will be discussed in detail below, the electric cooker according to the invention Includes an upper burner and a lower burner which are adjustably coupled to a control platform. The lower burner is coupled to a pair of wheels (at least one of which is provided with a ratchet stop) which are rotatable about a horizontal axis such that the lower burner can be angled up from horizontal to 45° or more. The upper burner is coupled to the wheels by a pair of floating hinges so that the space between the upper and lower burners is automatically adjustable. The floating hinges are provided with notches and the control platform has a pair of movable bosses which engage the notches to keep the upper burner spaced a fixed distance above the lower burner If desired. The floating hinges also allow for a full 180° rotation so that the upper and lower burners can be arranged as side by side burners. The control platform has separate digital temperature controls for the two burners and is also equipped with a digital timer which automatically turns the cooker off. A plurality of different cooking plates are removably coupled to the burners. These plates include a smooth griddle plate, a ribbed grill plate, a waffle plate, as well as a saute pan. A removable drip tray is mounted in the control platform under the lower burner. The griddle plate, the grill plate and the waffle plate each have drip gutters which allow grease to drain onto the drip tray when the burners are angled up from horizontal.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of the cooker in a contact grill position;

FIG. 2 is a perspective view of the cooker in the tilted drip position;

FIG. 3 is a perspective view of the cooker in the half open position;

FIG. 4 is a perspective view of the cooker in the full open position;

FIG. 5 is a perspective view of the cooker with the upper and lower burners in the manually selected spaced apart position;

FIG. 6 is a perspective view of an interchangeable griddle plate;

FIG. 7 is a perspective view of an interchangeable grill plate:

FIG. 8 is a perspective view of an interchangeable waffle plate;

FIG. 9 is a perspective view of a saute pan;

FIG. 10 is a broken side elevation view of the time and temperature indicators;

FIG. 11 is a broken side elevation view of the time and temperature setting buttons;

FIG. 12 is a perspective view of the underside of a cooking plate illustrating male and female couplings for removable mating with a burner;

FIG. 13 is a perspective view of an exposed burner illustrating male and female couplings for mating with a cooking plate;

FIG. 14 is a broken perspective view showing in a cut away schematic illustration a ratchet mechanism on one of the wheels;

FIGS. 15 and 16 are broken perspective views showing operation of one of the floating hinges;

FIGS. 17 and 18 are broken side elevation views showing operation of one of the movable bosses;

FIG. 19 is a broken perspective view showing the boss engaging notch in one of the floating hinges; and

FIG. 20 is a simplified schematic diagram of the cooker control circuit.

### DETAILED DESCRIPTION

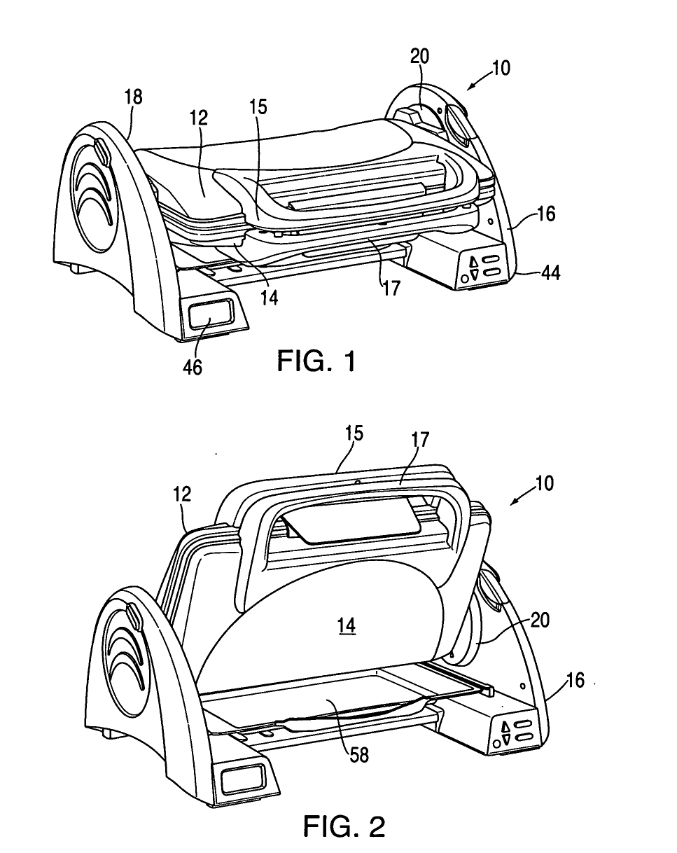

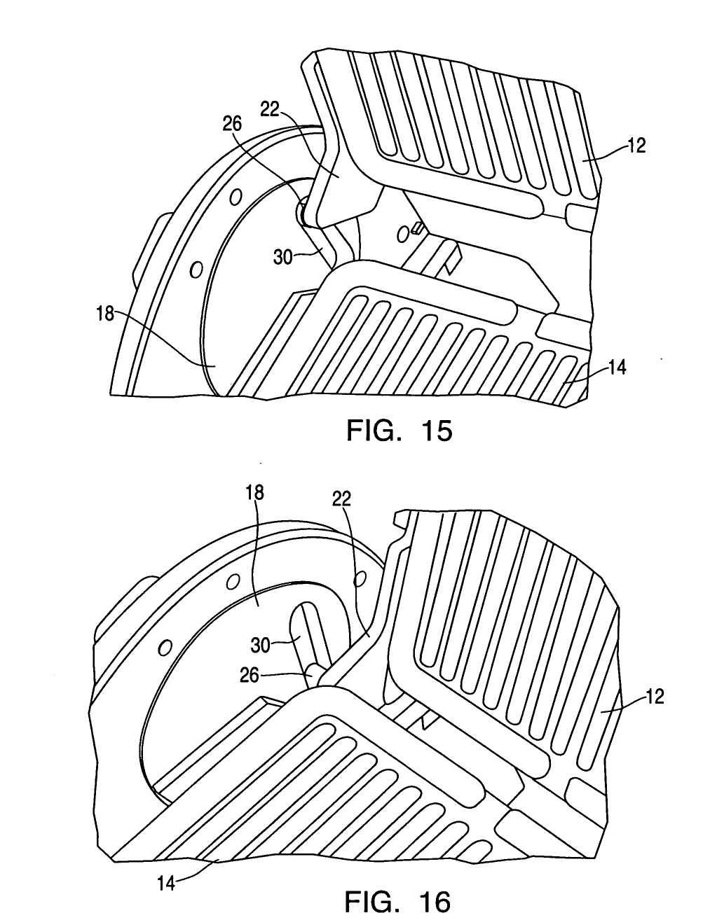

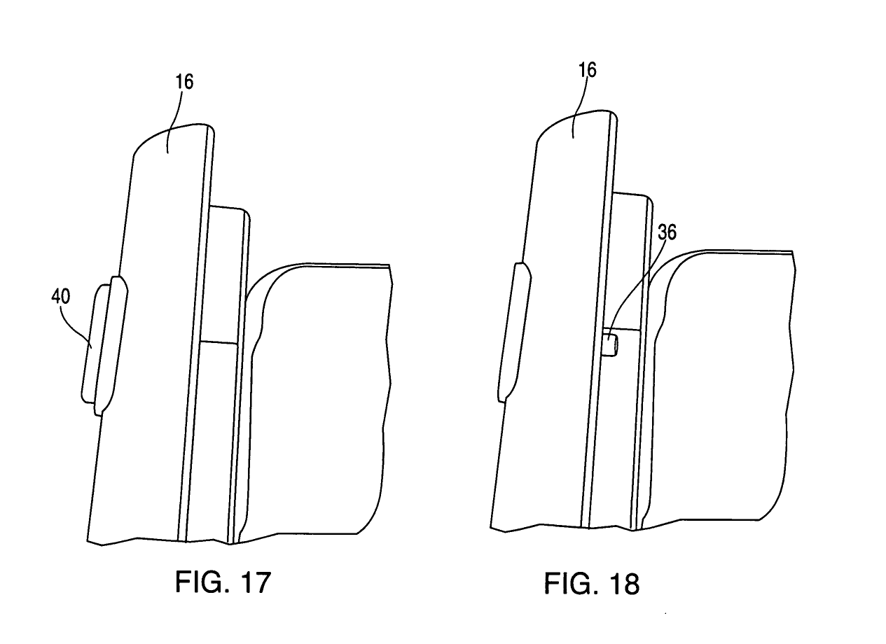

Turning now to FIG. 1, the electric cooker 10 according to the invention includes an upper burner 12 and a lower burner 14 which are adjustably coupled to a control platform 16. The lower burner 14 is coupled to a pair of wheels 18, 20 (seen best in FIGS. 14-16) which are rotatable about a horizontal axis such that the lower burner 14 can be angled up from horizontal (FIG. 1) to 45° or more (FIG. 2). The wheel 20 is provided with ratchet teeth 21 and a movable pawl 23 is coupled to a push button 25 (FIG. 14). The pawl 23 engages the teeth 21 to maintain the wheel 20 at a selected angle. When the button 25 is pressed, the pawl 23 is released from the teeth 21 to allow the wheel 20 to be rotated. As illustrated, each burner is provided with a handle 15, 17 which aids in moving the burners to the different positions shown in FIGS. 1-5. The handles can also be used to transport the cooker from storage to counter top and back.

As seen best in FIGS. 14-16, the upper burner 12 is coupled to the wheels 18, 20 by a pair of floating hinges 22, 24. The hinges include pins 26, 28 which engage slots 30, 32 in respective wheels 18, 20. The floating hinges allow the distance between the burners to automatically spread apart and come together depending on the thickness of the food being cooked.

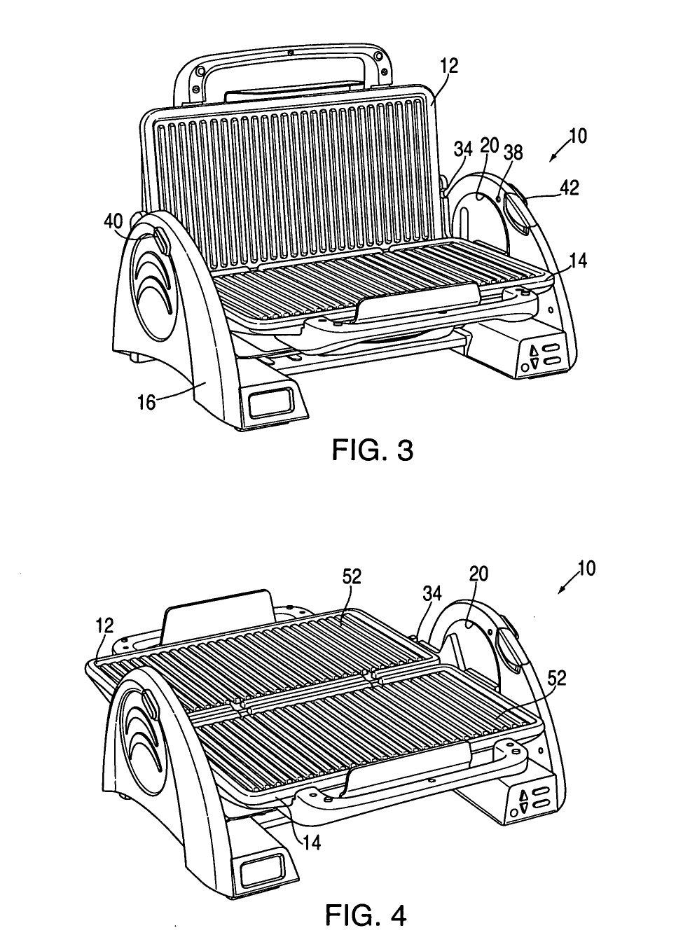

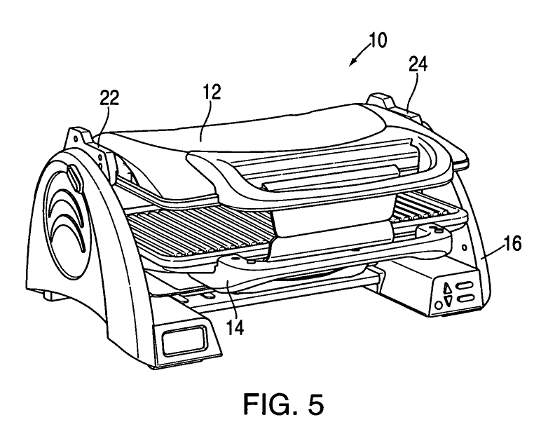

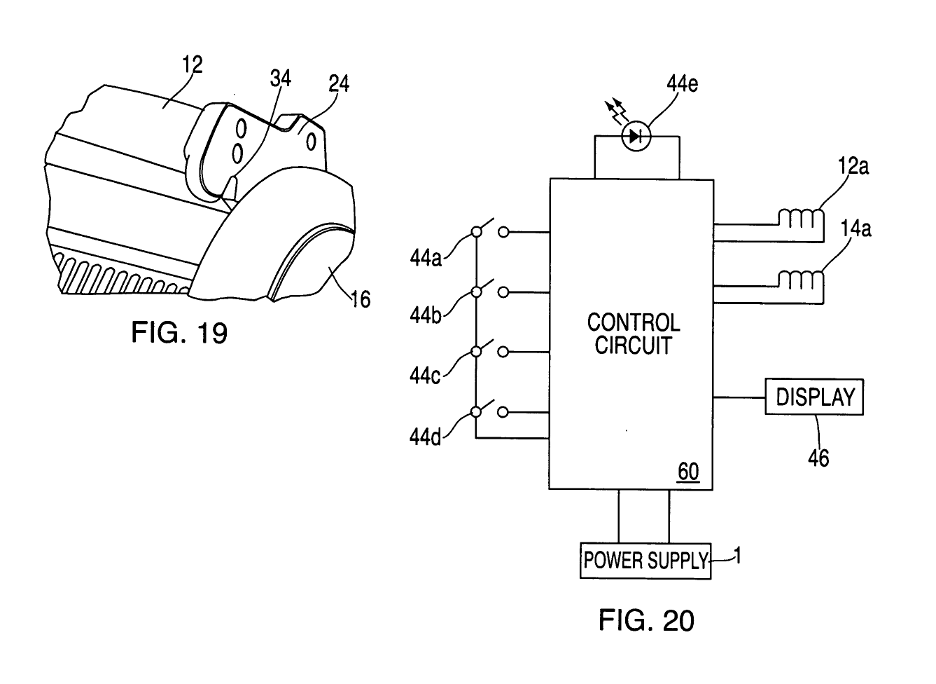

The hinges 22, 24 are also each supplied with a notch, e.g. 34 In FIG. 19, and the control platform 16 has a pair of movable bosses 36, 38 (see FIGS. 3, 14 and 18 for example) which are movable by respective spring biased click buttons 40, 42. When the bosses are extended as shown for example in FIG. 18, they are in a position to engage the notches of the hinges 22, 24 to keep the upper burner 12 spaced a fixed distance above the lower burner 14 as shown In FIG. 5. The floating hinges 22, 24 also allow for a full 180° rotation so that the upper and lower burners can be arranged as side by side burners as shown in FIG. 4.

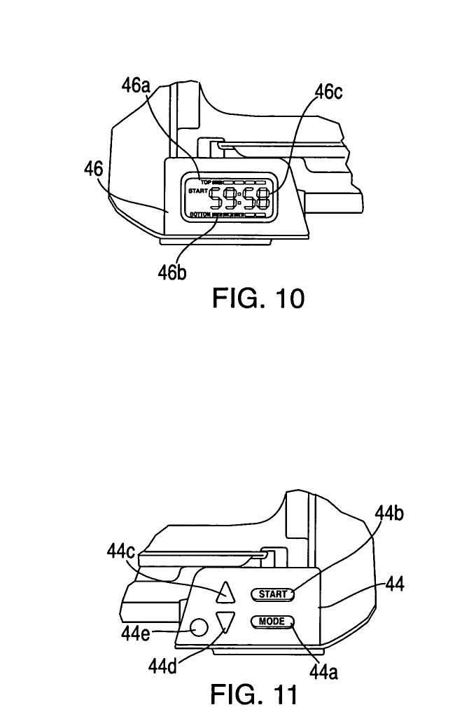

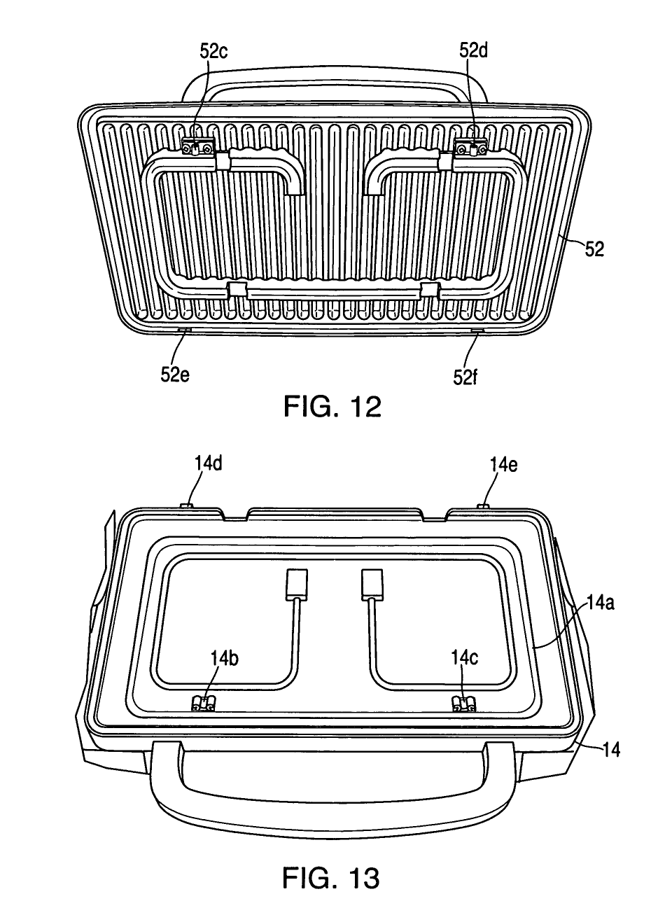

Referring now to FIGS. 1, 10, and 11, the control platform 16 has a control button panel 44 and a digital display 46. The control button panel includes a mode selector 44a, a start button 44b, up and down selectors 44c, 44d and a ready light 44e. The digital display 46 includes an upper burner temperature indicator 46a, a lower burner temperature indicator 46b, and a timer display 46c. The temperature Indicators 46a, 46b consist of five bars each. The bars indicate temperature as shown in Table 1, for example.

TABLE 1

| Bars | Setting | Temperature |
|---|---|---|
| No bar | Off | 0 |
| 1 bar | Low-lowest setting | 250 F. |
| 2 bars | Low-Med setting | 300 F. |
| 3 bars | Medium setting | 350 F. |
| 4 bars | Med-High setting | 400 F. |
| 5 bars | High-Highest setting | 450 F. |

The mode button 44a on the control panel is used to scroll through and select the temperature and timer functions. The mode button is pressed once to select the top plate. The up/down buttons 44c, 44d are then used to select the number of bars. The mode button is pressed twice to set the bottom plate. The up/down buttons 44c, 44d are then used to select the number of bars. The mode button is pressed a third time to set the timer setting (cook time) using the up/down buttons. When the time and temperatures are set, the start button 44b is pressed to start cooking. The ready light 44e is preferably a multicolor LED which glows one color, e.g. red, when heating up and another color, e.g. green, when temperature has been reached.

FIG. 20 shows an exemplary control circuit 60 coupled to the push buttons 44a-44d, the LED 44e, the display 46 as well as burner heating elements 12a, 14a and a power supply, 1. The power is preferably provided by a household electrical outlet supplying approximately 110 v and 20 amps.

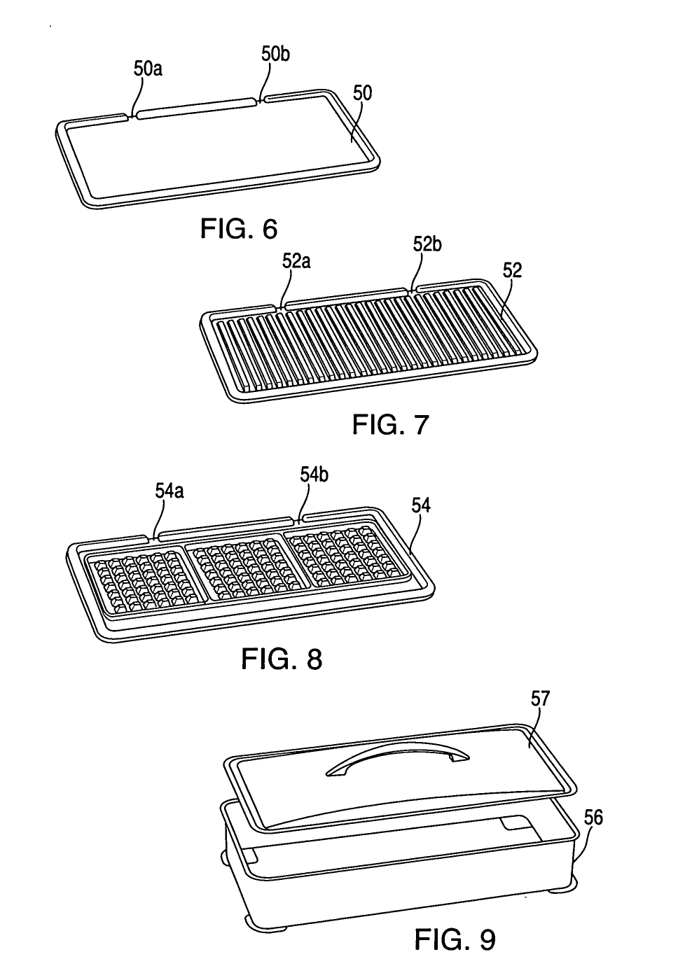

FIGS. 6-8 Illustrate a plurality of different cooking plates, for example a smooth griddle plate 50, a ribbed grill plate 52, and a waffle plate 54. Each plate has a different cooking surface. Typically, a pair of plates having the same cooking surface are coupled to respective upper and lower burners as shown for example in FIGS. 3, 4. However, it is possible to couple different cooking plates to respective burners. For example, in the side by side arrangement shown in FIG. 4, it might be desirable to replace one of the grill plates 52 with a griddle plate 50 when cooking, for example, sausage and eggs. Moreover, an optional sauteing pan 56 with a removable lid 57, shown in FIG. 9, can be positioned on one of the cooking plates when the burners are side by side as shown In FIG. 4. Each of the cooking plates is provided with two drain gutters 50a, 50b, 52a, 52b, 54a, 54b. When the cooker is put In the tilted position shown in FIG. 2, the gutters on the grill plates allow grease to drip out onto a removable drip tray 58.

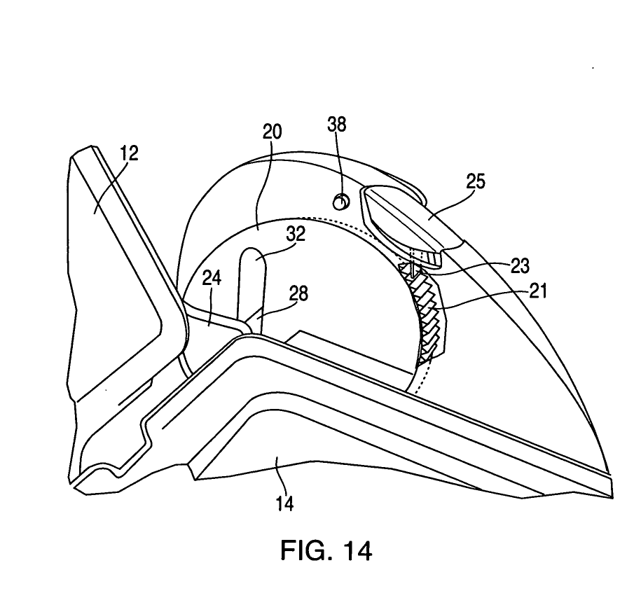

The different cooking plates are removably coupled to the burners via male and female connectors. In particular, as shown in FIGS. 12 and 13, the cooking plates, e.g. plate 52, have two male connectors 52c, 52d and two female connectors 52e, 52f. The burners, e.g. burner 14, have two female connectors 14b, 14c and two male connectors 14d, 14e. The male connectors 52c, 52d on the plate 52 are snap in connectors which mate with spring clips 14b, 14c on the burner 14. The female connectors 52e, 52f on the plate 52 are side wall slots which mate with horizontal tabs 14d, 14e on the burner 14.

There have been described and illustrated herein a multifunction electric cooker. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An electric cooker comprising:
a control platform;
a bottom burner rotatably coupled to said control platform and movable from a horizontal position to a tilted position of at least approximately 45°;
a top burner hingedly coupled to said bottom burner and movable from a position parallel to and on top of said bottom burner to a position substantially coplanar and along side of said bottom burner;
a bottom cooking plate removably coupled to said bottom burner and having a drain gutter;
a top cooking plate removably coupled to said top burner and having a drain gutter; and
a removable drip pan seated on said control platform beneath said bottom burner, wherein
said control platform includes means for individually setting the temperatures of said top and bottom burners such that the top burner may be set at one temperature while said bottom burner is set at the same or a different temperature.

2. The cooker according to claim 1, wherein:
said means for setting the temperatures includes a plurality of buttons and a digital display.

3. The cooker according to claim 1, wherein:
said top burner is hingedly coupled to said bottom burner by a floating hinge.

4. The cooker according to claim 3, further comprising:
means for holding said top and bottom burners substantially parallel and spaced apart from each other.

5. The cooker according to claim 4, wherein:
said means for holding said top and bottom burners substantially parallel and spaced apart from each other includes a notch in each hinge and a pair of movable bosses.

6. The cooker according to claim 5, wherein:
said bosses are each coupled to a spring biased button.

7. The cooker according to claim 1, wherein:
said bottom burner is rotatably coupled to said control platform by a ratchet wheel.

8. The cooker according to claim 7, wherein;
said ratchet wheel is engaged by a movable pawl.

9. The cooker according to claim 1, wherein:
said top cooking plate and said bottom cooking plate each have two male connectors and two female connectors.

10. The cooker according to claim 9, wherein:
said top burner and said bottom burner each have two male connectors and two female connectors which mate with the connectors on said plates.

11. The cooker according to claim 1, wherein:
each burner has a handle.

12. A kit, comprising:
an electric cooker having
a control platform;
a bottom burner rotatably coupled to said control platform and movable from a horizontal position to a tilted position of at least approximately 45°;
a top burner hingedly coupled to said bottom burner and movable from a position parallel to and on top of said bottom burner to a position substantially coplanar and along side of said bottom burner; and
a plurality of cooking plates, each having a different cooking surface and each being removably couplable to said burners.

13. The kit according to claim 12, further comprising:
a saute pan removably receivable on one of said cooking plates; and
a lid removably mountable on said saute pan.

14. The kit according to claim 12, further comprising:
a removable drip pan adapted to be pan seated on said control platform beneath said bottom burner.

15. The kit according to claim 12, wherein:
said control platform includes means for individually setting the temperatures of said top and bottom burners such that the top burner may be set at one temperature while said bottom burner is set at the same or different temperature.

16. The kit according to claim 12, wherein:
said top burner is hingedly coupled to said bottom burner by a floating hinge.

17. The kit according to claim 12; wherein:
said bottom burner is rotatably coupled to said control platform by a ratchet wheel.

18. The kit according to claim 17, wherein:
said ratchet wheel is engaged by a movable pawl.

19. The kit according to claim 12, wherein:
each burner has a handle.
